(19) United States
(12) Patent Application Publication
(10) Pub. No.: US 2015/0168286 A1
(43) Pub. Date: Jun. 18, 2015

(54) METHOD FOR DETERMINING CHANGES IN PARAMETERS OF A POROUS MEDIUM SUBJECTED TO A CONTAMINANT

(71) Applicant: SCHLUMBERGER TECHNOLOGY CORPORATION, Sugar Land, TX (US)

(72) Inventors: Dmitry Nikolaevich Mikhailov, Moscow (RU); Nikita Ilyich Ryzhikov, Moscow (RU); Alexander Alexandrovich Burukhin, Moscow (RU); Anna Viktorovna Zharnikova, Moscow (RU)

(21) Appl. No.: 14/573,712

(22) Filed: Dec. 17, 2014

(30) Foreign Application Priority Data
Dec. 18, 2013 (RU) 2013156000

(51) Int. Cl. G01N 15/08; G01N 29/024

(52) U.S. Cl. CPC G01N 15/088; G01N 29/024

(57) ABSTRACT

A source and a receiver of acoustic waves are placed on opposite surfaces of a porous medium sample. A first irradiation of at least one part of the sample with longitudinal acoustic waves is carried out. A propagation velocity of the longitudinal acoustic waves is determined. An empirical relationship between a propagation velocity of a longitudinal acoustic wave and a porosity for a given type of the porous medium based on the porosity and a saturation behavior of the sample is selected. A filtration experiment by injecting a contaminant mud through the sample is carried out. A second irradiation of the same portion of the sample with longitudinal acoustic waves is performed and a propagation velocity of the longitudinal acoustic waves is measured. A porosity change in this part of the sample is determined based on the velocities of the longitudinal acoustic waves measured prior to and after the injection of the contaminant and using the selected empirical relationship.

### CROSS-REFERENCE TO RELATED APPLICATION

This application claims priority to Russian Application No. 2013156000 filed Dec. 18, 2013, which is incorporated herein by reference in its entirety

### BACKGROUND

The invention rerates to methods for non-destructive analyzing samples of porous materials; in particular, it can be used for quantitative studying a deterioration of properties in a near-borehole zone of oil/gas-containing formations due to penetration of drilling mud components therein.

The problem of damaging the near-borehole zone of the formation when subjected to penetrated components of the drilling mud (or a flushing fluid) is very important, especially for long horizontal boreholes, because the most of them are completed in the uncased state, i.e., without a cemented and perforated production string.

Drilling muds are complex mixtures of polymers, particles (having a size from hundreds of micrometers to less than one micron), clays, and other additives contained in a “carrier” fluid being “a base” of the drilling mud; water, oil, or some synthetic fluid can act as the carrier fluid.

In the process of drilling influenced by an excessive pressure, a filtrate of a drilling mud as well as fine particles contained therein, polymers and other components penetrate into a near-borehole zone of a formation and cause significant reduction in the permeability thereof. In addition, an external filter cake comprised of filtered solid particles and other components of the drilling mud is formed on a wall of a borehole.

During the technological procedure of cleaning the borehole (by gradual putting into production), the external filter cake is partially broken while the penetrated components of the drilling mud are partially washed out of the near-borehole zone, and its permeability is partially restored. Nevertheless, a portion of components remains irreversibly held in a pore space of a rock (adsorption on surfaces of pores, capture in steam restrictions, etc.) which results in an essential difference between an initial permeability and a permeability restored after carrying out the technological cleaning procedure (usually, the restored permeability is not greater than 50 to 70% of the initial permeability).

The conventional laboratory technique for checking a quality of a drilling mud is a filtration experiment for pumping the drilling mud into a core sample followed by back pumping (i.e., displacement of the penetrated drilling mud with an initial formation fluid) in progress of which a permeability deterioration/restoration dynamics as a function of an amount of pore volumes filled with pumped fluids (the drilling mud or the formation fluid) is measured.

Said conventional technique allows measurement only of an integral hydraulic resistance of a core sample (a ratio of a current pressure differential across the core to a current flow rate), the change of which is caused by the growth/destruction dynamic of the external filter cake at an end face of the core and by accumulation/removal of the drilling mud components in the rock.

However, a damaged porosity and permeability profile along the core sample (i.e., along a filtration axis) after pumping of the drilling mud in (or after back pumping) is important information to understand the formation damage mechanism and to select a respective technique for increasing a wellbore productivity index (to minimize a damage of a bottomhole formation zone). The present parameters are not measured within said traditional procedure of the drilling mud quality check.

To determine said parameters, it is necessary to attract additional techniques. US 2003/0217599 published on Nov. 7, 2003, comprises a method for determining defects contained within porous media, such as a membrane, using plate waves. The plate waves create a fast compression wave and a slow compression wave within the porous medium under study. In doing so, the fast compression wave provides information about the total porosity of a medium under study, while the slow compression wave provides information about the presence of defects in the porous medium or the types of materials that form the porous medium under study.

US 2009/0168596 of Jul. 2, 2009, discloses a method for estimating formation porosity and lithology on a real time basis during a logging while drilling operation using measured values of formation attenuation attributes for compression and/or shear waves. Measured attributes are used with an empirical lithology map to determine lithology, porosity and saturation of a production level when these are unknown.

US 20011/0242938 of Oct. 6, 2001, discloses methods and embodiments of analyzing core samples taken from a borehole. The disclosed methods may include extracting a first core sample from a wellbore with a coring tool at a first depth, ultrasonically measuring a sound speed of the first core sample, transmitting the ultrasonically measured sound speed of the first core sample to a display unit, analyzing the ultrasonically measured sound wave speed in real time, extracting a second core sample at the first depth if the first core sample is determined to be low quality, and extracting the second core at a second depth if the first core is determined to be high quality. US 20011/0242938 further declares determination of one of the parameters as follows: homogeneity, integrity, and lithology of core samples based on the obtained ultrasonic wave profile.

All said patents are directed to determine properties of the porous medium, such as porosity, saturation behavior, lithology based on attributes of waves propagating through a sample of the porous medium under study. Said patents doe not stipulate determination of a change in properties of the porous medium, said change resulting from action of a contaminant.

### SUMMARY

The disclosure provides for determining a change of porous medium properties in a near-borehole zone of a formation, said change resulting from action of a contaminant.

In accordance with the method for determining changes in parameters of a porous medium subjected to a contaminant, a source of acoustic waves and a receiver of acoustic waves are placed on opposite surfaces of a porous medium sample. A first irradiation of at least one part of the porous medium sample with longitudinal acoustic waves is carried out and a propagation velocity of the longitudinal acoustic waves is measured. Then, an empirical relationship between a propagation velocity of a longitudinal acoustic wave and a porosity for a given type of the porous medium is selected based on the porosity and a saturation behavior of the sample. Next, a filtration experiment is performed by injecting a contaminant mud through the porous medium sample and a second irradiation of the same part of the sample with longitudinal acoustic waves is carried out. A propagation velocity of the longitudinal acoustic waves is measured. A porosity change in this part of the porous medium sample is determined based on the longitudinal acoustic wave propagation velocities measured before and after the injection of the contaminant and using the selected empirical relationship.

The source and the receiver of the acoustic waves can be placed such that their maximum sensitivity axes coincide.

A core of a mountain rock can be used as the sample of the porous material while a drilling mud can be used as the contaminant. The core can be extracted preliminary.

The porosity of the porous medium sample can be measured preliminary.

An analytic dependence or a dependence in the form of a nomographic chart or a dependence according to the Frenkel-Biot-Nikolaevsky theory can be used as the empirical relationship between a propagation velocity of the longitudinal acoustic wave and a porosity.

In accordance with one of embodiments of the disclosure, the filtration experiment comprising injection of the contaminant mud through the porous medium sample is followed by further injection of a formation fluid, said formation fluid being injected from an end face opposite to the end face from which the contaminant mud was injected.

In accordance with another embodiment of the disclosure, the porous medium sample is dried to complete removal of a pore moisture prior to each measurement of the propagation velocity of the longitudinal acoustic waves.

In accordance with another embodiment of the disclosure, the source and the receiver of acoustic waves are disposed perpendicularly to a contaminant filtration axis, the source and the receiver are moved stepwise along the contaminant filtration axis, and, at each movement step, the first and the second irradiations of a sample part along the contaminant filtration axis are carried out, longitudinal acoustic waves velocities are measured during the first and the second irradiations in different sample parts along the contaminant filtration axis, and a changed porosity profile is determined.

In accordance with other embodiment of the disclosure, a core of a mountain rock is used as the sample of the porous material, a drilling mud is used as the contaminant, while the determined changed porosity profile is used to correct an interpretation of acoustic logging data.

In accordance with another embodiment of the disclosure, a longitudinal wave attenuation factor or amplitude is measured at least in one sample part during the first and second irradiations of the core with the longitudinal acoustic waves. Based on saturation behavior of the porous medium sample, an empirical relationship between a longitudinal acoustic wave attenuation or amplitude and a permeability is selected for a given type of the porous medium, and a permeability change is determined using the selected empirical relationship between the longitudinal acoustic wave attenuation or amplitude and the permeability for the given type of the porous medium.

An analytic dependence or a dependence in the form of a nomographic chart or a dependence according to the Frenkel-Biot-Nikolaevsky theory can used as the empirical relationship between the longitudinal acoustic wave attenuation or amplitude and the permeability.

The permeability of the porous medium sample can be measured preliminary.

In accordance with other embodiment of the disclosure, the source and the receiver of the acoustic waves can be placed perpendicularly to a contaminant filtration axis. The source and the receiver are moved stepwise along the contaminant filtration axis and, at each movement step, an attenuation factor or amplitude of a longitudinal acoustic wave is measured during the first and second irradiations in different sample parts along the contaminant filtration axis, and a changed permeability profile is determined.

### BRIEF DESCRIPTION OF DRAWINGS

The invention is illustrated by the drawing where:

FIG. 1 is an example diagram for irradiation of a core sample with ultrasonic waves in different points along its axis (a filtration direction);

FIG. 2 shows a result of measuring a velocity of a longitudinal ultrasonic wave in different core points after a filtration experiment (injection of a slurry of SiC particles in 1% polymeric Xanthan solution);

FIG. 3 shows a result of calculating a changed porosity profile along the core after the filtration experiment (injection of a slurry of SiC particles in the 1% polymeric Xanthan solution).

### DETAILED DESCRIPTION

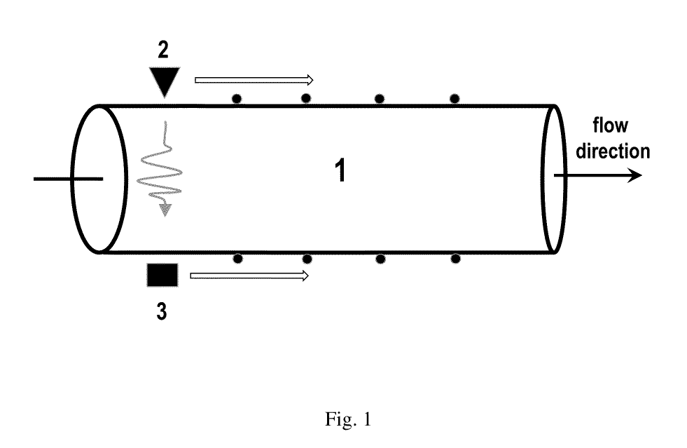

The non-destructive method for recording and profiling a change in properties of a porous medium is based on the variation analysis of attributes of a longitudinal acoustic wave when it passes through different portions of a damaged sample and an initial, undamaged sample of the porous medium. Use of ultrasonic wave is considered as an example. As shown in FIG. 1, an acoustic ultrasonic wave source 2 and an acoustic ultrasonic wave receiver 3 are placed on opposite surfaces of a porous medium sample 1. At least one part of the sample is first irradiated with longitudinal ultrasonic waves and a propagation velocity of the longitudinal ultrasonic waves is measured. Based on a porosity estimated theoretically or preliminary measured (for example, according to the standard methodology of the All-Union State Standard (GOST) 26450.1-85 “Porody gornye. Metody opredelenia kollectrorskikh svoistv. Metod opredelenia koeffitsienta otkrytoi poristosti zhidkostenasyshcheniem” (Mountain rocks. Methods for determining reservoir properties. Method for determining the open porosity ratio by saturation with fluid), USSR 1985) and a sample saturation behavior, an empirical relationship between a wave velocity and the porosity for a given type of the porous medium is selected. A filtration experiment is carried out by injecting a contaminant mud through the porous medium sample; a filtration direction 4 is shown in FIG. 1. A second irradiation of the same portion of the sample with longitudinal ultrasonic waves is performed, and a propagation velocity of the longitudinal ultrasonic waves in this part is measured. A variation of the longitudinal ultrasonic wave velocity is used to record the porosity change.

Implementation of the invention in accordance with one of the methods stated below allows to determine not only the porous medium porosity change but the porous medium permeability change as well. To this end, further measuring a longitudinal wave attenuation factor or amplitude is measured during the first and second irradiations of the sample with the ultrasonic waves. Based on a permeability estimated theoretically or measured preliminary (for example, according to the standard methodology of the GOST 26450.1-85 “Porody gornye. Metod opredelenia koeffitsienta absolutnoi pronitsaemosti pri statsionarnoi ili nestatsionarnoi filtratsii” (Mountain rocks. Method for determining the absolute permeability coefficient in stationary or non-stationary filtration), USSR 1985) and a saturation behavior, an empirical relationship between a wave attenuation and a permeability for a given type of the porous medium is selected. A variation of an ultrasonic wave attenuation coefficient of amplitude is used to record the permeability change.

It is common knowledge that a velocity and an attenuation factor of acoustic waves in a porous medium depends upon such properties of the porous medium as porosity, permeability, compressibility and density of phases which constitute it, etc.

The theory of wave propagation in porous media developed by Frenkel, Biot and Nikolaevsky (cf., Biot, M. A. Theory of propagation of elastic waves in a fluid-saturated solid. I. Low frequency range//J. Acoust. Soc. Amer. 1956. V. 28. P. 168-178. II. Higher frequency range//J. Acoust. Soc. Amer. 1956. V. 28. P. 179-191, or Nikolaevsky, V. N. Geomechanics and Fluidodynamics with applications to reservoir engineering. SpringerVerlag, Dordrecht, 1996, pp. 50-57, 65-72) forecasts the existence of two types of longitudinal waves: a “fast” wave (or a longitudinal first-type wave) and a “slow” wave (or a longitudinal second-type wave). The second-type wave within a frequency range of from 0.5 to 10 MHz, which corresponds to typical laboratory measurements, is defined by intensive attenuation, especially in saturated rocks, and therefore cannot propagate for any significant distances.

Thus, the present disclosure is limited to consideration of attributes of the longitudinal first-type wave only.

Other consequence of the Frenkel-Biot-Nikolaevsky theory is the longitudinal first-type wave velocity versus rock density dependence as well as saturating fluid compressibility and density and rock matrix. The first-type wave attenuation factor and dispersion depend upon a rock permeability as well (i.e., there is the phase velocity-frequency dependence).

Simple empirical correlations are usually used in interpretation of acoustic logging data. For example, the time-average equation (or Willie equation) which correlates a wave interval transit time and a rock porosity (cf., Log interpretation principles/applications by Schlumberger. 1989, Chapter 5, p. 6) is widely used to estimate the porosity in a dense, well-cemented rock:

$${t}_{LOG} = φ {t}_{f} + ( 1 - φ ) {t}_{ma} , or \\ φ = \frac{{t}_{LOG} - {t}_{ma}}{{t}_{f} - {t}_{ma}} , \qquad ( 1 )$$

where φ is the rock porosity; t_{LOG} is the interval transit time for transiting the wave though the rock, as recorded in acoustic logging; tₘₐ is the wave interval transit time in a mineral rock matrix; t_{f} is the wave interval transit time in a saturating fluid.

The equation (1) corresponds to the fact that a longitudinal wave interval transit time (i.e., a time of wave propagation along the path of the unit length, and therefore, said time is reversely proportional to a value of a wave velocity) in the dense, well-cemented rock is a volume-averaged value of the wave interval transit time in the mineral rock matrix and in the fluid filling the pore space.

An empirical correction factor Cₚ is introduced to estimate the porosity of poorly cemented rocks on the basis of acoustic logging data (cf., Log interpretation principles/applications by Schlumberger. 1989, Chapter 5, p. 7):

$${φ}_{cor} = \frac{{t}_{LOG} - {t}_{ma}}{{t}_{f} - {t}_{ma}} \frac{1}{{C}_{p}} \qquad ( 2 )$$

Other empirical correlations (analytical or in the form of a nomographic chart) also exist between the wave transit time and the porosity, said correlations having been obtained for different rock types (cf., Vendel'shtein, B. Ju., Rezvanov, R. A. “Geofizicheskie metody opredeleniya parametrov nefnegazovykh kollectorov pri podschete zapasov i proektirovanii razrabotki mestorozhdeny” (Geophysical techniques for determining oil and gas reservoirs in calculation of reserves and design of development of deposits). Moscow, “Nedra” (Depths Publishers), 1978, pp. 132-143; “Inerpratatsia rezul'tatov geofizicheskikh issledovany neftyanykh i gasovykh skvazhin” (Interpretation of results in geophysical studies of oil and gas boreholes). Reference book. Moscow: “Nedra”, p. 176).

Penetration of drilling mud components leads to reduction in the porosity from an initial value φ₀:

φ_{d}=φ₀−σ, (3)

where σ is a proportion by volume of captured particles per volume unit of a porous medium.

The porosity reduction, in turn, gives rise to the longitudinal wave velocity (results in decrease of the interval transit time).

A degree of the porosity damage (change) can be quantitatively estimated on the basis of the measured values of the longitudinal wave propagation velocity (interval transit time) in a core sample subjected to a drilling mud and in a core sample of the similar lithological type (lithotype) with the original, undamaged porosity, said estimation being carried out using a known empirical (analytical or in the form of a nomographic chart) relationship between the wave transit time and the porosity for a given rock type, cf., Wyllie M. R. J., Gregory A. R., Gardner G. H. F. An experimental investigation of factors affecting elastic wave velocities in porous media. 1958,Vol. 23, No. 3, pp. 459-493, or being carried out on the basis of the Frenkel-Biot-Nikolaevsky theory, cf., Biot M. A. Theory of propagation of elastic waves in a fluid-saturated solid. I. Low frequency range//J. Acoust. Soc. Amer., 1956, V. 28, pp. 168 to 178. II. Higher frequency range//J. Acoust. Soc. Amer. 1956, V. 28, pp. 179-191, or Nikolaevskiy V. N. Geomechanics and Fluidodynamics with applications to reservoir engineering. SpringerVerlag, Dordrecht, 1996, pp. 50-57, 65-72).

For example, a degree of the porosity change for the correlation (1) is determined as:

$$\frac{{φ}_{0}}{{φ}_{d}} = \frac{{t}_{LOG}^{0} - {t}_{ma}}{{t}_{LOG}^{d} - {t}_{ma}} , \qquad ( 4 )$$

where t^{d}_{LOG} [symbol] t⁰_{LOG} are interval times of transiting the wave through the core sample subjected to the drilling mud and the core sample of the similar lithotype with the initial, undamaged porosity, respectively.

The obtained data of a depth and a degree of the porosity reduction can be uses to correct the interpretation of acoustic logging data.

Using the Frenkel-Biot-Nikolaevsky theory, a change of the rock permeability can be estimated on the basis of the measured values of the longitudinal wave attenuation factor in the contaminated sample and the initial, uncontaminated sample.

The measurement of the porosity and permeability damages associated with penetration of the slurry of SiC particles having a size of 5 μm into the sample of Bentheimer sandstone having the permeability to water of 3,200 mD and the porosity of 23.5% is recited as an example.

Since Bentheimer sandstone is a well-cemented rock, the empirical time-average equation (1) can be applied thereto.

After measurement of the porosity and after injection of the slurry of SiC particles, the sample was placed onto a special podium with a diametric system for positioning acoustic sensors. Ultrasonic transducers Panametrics V103-RM were used to radiate and receive acoustic waves, a sensor aperture was 1.3 cm and a main frequency was 1 MHz. The positioning system made it possible to mount the ultrasonic transducers (the radiator and the receiver) diametrically and move them along the sample. A profiling step was 2 mm. A longitudinal wave transit time was measured at each step and a wave propagation velocity was calculated on the basis of said time.

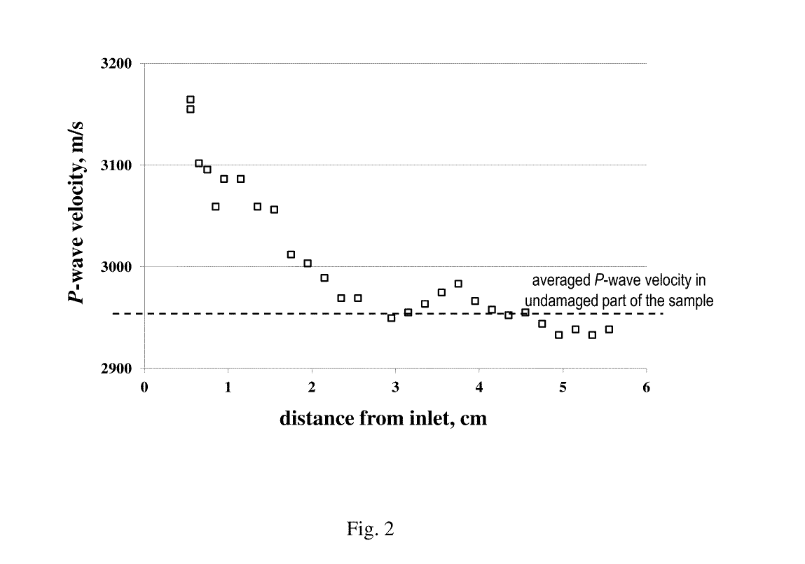

FIG. 2 is a result of measuring a longitudinal ultrasonic wave propagation velocity in different points of the core after the filtration experiment (injecting the SiC particle slurry in the 1% Xanthan solution). An average propagation velocity of the longitudinal wave in the original, “uncontaminated” sample was about 2,950 m/s (dashed line in FIG. 2).

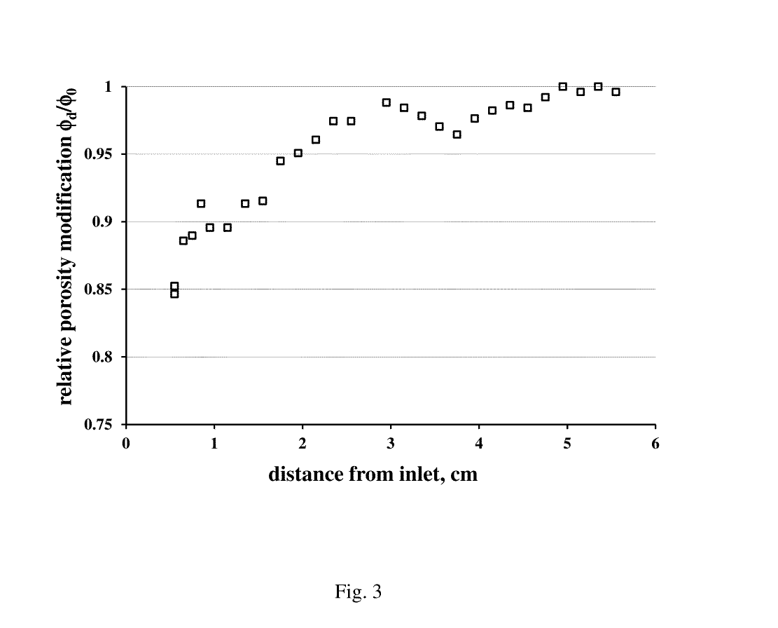

A profile of the changed porosity along the core after the filtration experiment (injecting the SiC particle slurry in the 1% Xanthan solution) was calculated using the relationship (4), see FIG. 3.

1. A method for determining changes in parameters of a porous medium subjected to a contaminant, comprising:
placing a source of acoustic waves and a receiver of acoustic waves on opposite surfaces of a porous medium sample;
carrying out a first irradiation of at least one part of the porous medium sample with longitudinal acoustic waves and measuring a propagation velocity of the longitudinal acoustic waves;
selecting an empirical relationship between a longitudinal acoustic wave velocity and a porosity for a given type of the porous medium based on the porosity and a saturation behavior of the sample;
carrying out a filtration experiment by injecting a contaminant mud through the porous medium sample;
carrying out a second irradiation of the same part of the sample with longitudinal acoustic waves and measuring a propagation velocity of the longitudinal acoustic waves; and
determining a porosity change in this part of the porous medium sample based on the longitudinal acoustic wave rates measured before and after the injection of the contaminant and using the selected empirical relationship.

2. The method of claim 1, wherein the source and the receiver of acoustic waves are placed such that their maximum sensitivity axes coincide.

3. The method of claim 1, wherein a core of a mountain rock is used as the sample of the porous material and a drilling mud is used as the contaminant.

4. The method of claim 3, wherein the core is preliminary extracted.

5. The method of claim 1, wherein the porosity of the porous medium sample is measured preliminary.

6. The method of claim 1, wherein an analytic dependence is used as the empirical relationship between the velocity of the longitudinal acoustic wave and the porosity.

7. The method of claim 1, wherein a dependence in the form of a nomographic chart is used as the empirical relationship between the velocity of the longitudinal acoustic wave and the porosity.

8. The method of claim 1, wherein a dependence according to the Frenkel-Biot-Nikolaevsky theory is used as the empirical relationship between the velocity of the longitudinal acoustic wave and the porosity.

9. The method of claim 1, wherein the filtration experiment comprising injection of the contaminant mud through the porous medium sample is followed by further injection of formation fluid, said formation fluid being injected from an end face opposite to an end face from which the contaminant mud was injected.

10. The method of claim 1, wherein the porous medium sample is dried to complete removal of a pore moisture prior to each measurement of the velocity of the longitudinal acoustic waves.

11. The method according of claim 1, wherein the source and the receiver of acoustic waves is placed perpendicularly to a contaminant filtration axis, the source and the receiver are moved stepwise along the contaminant filtration axis, each movement step, the first and second irradiations longitudinal acoustic waves of a sample part along the contaminant filtration axis are carried out, velocities of the longitudinal acoustic waves during the first and second irradiations are measured and a changed porosity profile is determined.

12. The method of claim 11, wherein a core of a mountain rock is used as the porous material sample, while the obtained changed porosity profile is used to correct an interpretation of acoustic logging data.

13. The method of claim 1, wherein during the first and second irradiations of the sample with the longitudinal acoustic waves a longitudinal wave attenuation factor or amplitude at least in one sample part is measured, an empirical relationship between a longitudinal acoustic wave attenuation or amplitude and a permeability for a given type of the porous medium is selected based on a saturation behavior of the porous medium sample, and a permeability change is determined using the selected empirical relationship between the longitudinal acoustic wave attenuation or amplitude and the permeability for the given type of the porous medium.

14. The method of claim 13, wherein the permeability of the sample is preliminary measured.

15. The method of claim 13, wherein an analytic dependence is used as the empirical relationship between the longitudinal acoustic wave attenuation or amplitude and the permeability.

16. The method of claim 13, wherein a dependence in the form of a nomographic chart is used as the empirical relationship between the longitudinal acoustic wave attenuation or amplitude and the permeability.

17. The method according to claim 13, wherein a dependence according to the Frenkel-Biot-Nikolaevsky theory is used as the empirical relationship between the longitudinal acoustic wave attenuation or amplitude and the permeability.

18. The method according to claim 13, wherein the source and the receiver of the acoustic waves are placed perpendicularly to a contaminant filtration axis, the source and the receiver are moved stepwise along the contaminant filtration axis, and, at each movement step, the first and second irradiations of a sample part along the contaminant filtration axis by longitudinal acoustic wave are carried out, an attenuation factor or amplitude of the longitudinal acoustic waves during the first and second irradiations in different sample parts along the contaminant filtration axis are measured and a changed permeability profile is determined.
